(19) United States
(12) Patent Application Publication
(10) Pub. No.: US 2025/0224280 A1
(43) Pub. Date: Jul. 10, 2025

(54) SURFACE THERMOMETER

(71) Applicant: Hy Cite Enterprises, LLC, Middleton, WI (US)

(72) Inventors: Jeremy Michael Miller, Fitchburg, WI (US); Jose Juan Santiago, New York, NY (US); Craig Stevenson, Fitchburg, WI (US); Terri Zeman, Brooklyn, WI (US); Michael John Brucki, Madison, WI (US); Morad Ghassemian, Oak Park, IL (US); Ray Hubert, Muscoda, WI (US); Paola Galindo, Bogotá (CO); Phill Smart, Verona, WI (US); Paulo Moledo, Verona, WI (US); Belinda Long, Yunfu (CN)

(21) Appl. No.: 18/404,104

(22) Filed: Jan. 4, 2024

(51) Int. Cl. G01K 5/70

(52) U.S. Cl. CPC G01K 5/70

(57) ABSTRACT

A thermometer configured to detect a range of temperatures of a cooking surface includes a gauge including a first indicia and a second indicia, a thermometal operably connected to the gauge, and a stationary member defining a first aperture, the gauge configured to rotate relative to the stationary member. In response to the thermometal detecting a first range of temperatures, the gauge is configured to rotate relative to the stationary member to display the first indicia through the first aperture. In response to the thermometal detecting a second range of temperatures, the gauge is configured to rotate relative to the stationary member to display the second indicia through the first aperture.

### FIELD

The present disclosure relates to a thermometer used for cooking. More specifically, the present disclosure relates to a thermometer that detects a range of temperatures of a cooking surface and displays the detected range of temperatures through one or more indicia, at least one indicia representative of a temperature range of the cooking surface associated with improved food quality outcome while cooking.

### BACKGROUND

When cooking food with a pan, a skillet, or other cooking vessel, improper temperature control can lead to inconsistent or poor cooked food quality. A cooking vessel with too low of a temperature can lead to food sticking to a cooking surface. A cooking vessel with too high of a temperature can result in burning of the food, uneven heating of the food, difficult vessel cleanup, damage to the cooking vessel, and other undesirable outcomes. Accordingly, there is a need to detect a preferred temperature of a cooking vessel, and clearly and simply communicate that preferred temperature to a user to improve cooked food quality.

### SUMMARY

In one example of an embodiment, a thermometer configured to detect a range of temperatures of a cooking surface includes a gauge includes a first indicia and a second indicia, a thermometal operably connected to the gauge, and a stationary member defining a first aperture, the gauge configured to rotate relative to the stationary member. In response to the thermometal detecting a first range of temperatures, the gauge is configured to rotate relative to the stationary member to display the first indicia through the first aperture. In response to the thermometal detecting a second range of temperatures, the gauge is configured to rotate relative to the stationary member to display the second indicia through the first aperture.

In another example of an embodiment, a thermometer configured to detect a range of temperatures of a cooking surface includes a gauge includes a first indicia and a second indicia, a temperature detection member operably connected to the gauge, and a stationary member defining a first aperture, the gauge configured to rotate relative to the stationary member. In response to the temperature detection member detecting a first range of temperatures, the gauge is configured to rotate relative to the stationary member to display the first indicia through the first aperture. In response to the temperature detection member detecting a second range of temperatures, the gauge is configured to rotate relative to the stationary member to display the second indicia through the first aperture.

In another example of an embodiment, a thermometer includes a gauge including a first indicia, a second indicia, a third indicia, a fourth indicia, a fifth indicia, and a sixth indicia, a base, a temperature detection member received by the base and configured to detect a temperature of a surface upon which the base is positioned, the temperature detection member operably connected to the gauge and configured to rotate the gauge in response to changes in the detected temperature, and a stationary member defining a first aperture and a second aperture, the gauge configured to rotate relative to the stationary member. In response to the temperature detection member detecting a first range of temperatures, the gauge is configured to rotate relative to the stationary member to display the first indicia through the first aperture, and the fourth indicia through the second aperture. In response to the temperature detection member detecting a second range of temperatures, the gauge is configured to rotate relative to the stationary member to display the second indicia through the first aperture, and the fifth indicia through the second aperture. In response to the temperature detection member detecting a third range of temperatures, the gauge is configured to rotate relative to the stationary member to display the third indicia through the first aperture, and the sixth indicia through the second aperture.

Other aspects of the invention will become apparent by consideration of the detailed description and accompanying drawings.

### BRIEF DESCRIPTION OF THE DRAWINGS

FIG. 1 is a perspective view of an example of an embodiment of a thermometer illustrating a first side of the thermometer.

FIG. 2 is a perspective view of the thermometer of FIG. 1 illustrating a second side of the thermometer opposite the first side.

FIG. 3 is an exploded view of the thermometer of FIG. 1 illustrating the first side of the thermometer.

FIG. 4 is an exploded view of the thermometer of FIG. 1 illustrating the second side of the thermometer.

FIG. 5 is a cross-sectional view of the thermometer taken along line 5-5 in FIG. 1.

FIG. 6 is a cross-sectional view of the thermometer taken along line 6-6 in FIG. 1.

FIG. 7 is a plan view of a rotating gauge of the thermometer of FIG. 1.

FIG. 8 is a plan view of the rotating gauge and a stationary disc of the thermometer of FIG. 1, with the rotating gauge in a first position.

FIG. 9 is a plan view of the rotating gauge and the stationary disc of FIG. 8, with the rotating gauge in a second position.

FIG. 10 is a plan view of the rotating gauge and the stationary disc of FIG. 8, with the rotating gauge in a third position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

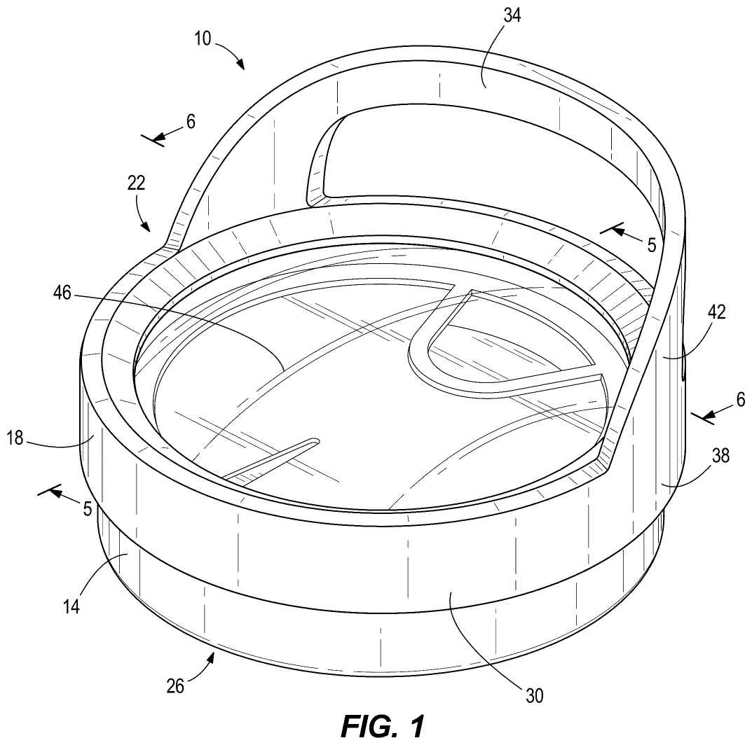

FIGS. 1-10 illustrate an example of an embodiment of a thermometer 10 (also referred to as a cooking thermometer 10). The thermometer 10 is configured to detect a temperature of a cooking surface, such as a pan, griddle, pot, or any other suitable surface used to cook food. Unlike known thermometers, which convey a specific temperature of the measured material to a user, the thermometer 10 communicates a preferred range of detected temperatures through a clear and concise indicia. The indicia represents a preferred detected range of cooking surface temperatures that is associated with an improved cooked food quality and an improved cooked food outcome. The thermometer 10 further provides an additional indicia in response to a detected cooking surface temperature that is outside of the preferred detected range. One indicia represents a detected cooking surface temperature that is below the preferred detected range of cooking surface temperatures (i.e., too cool). Another indicia represents a detected cooking surface temperature that is above the preferred detected range of cooking surface temperature (i.e., too hot). By simplifying communication of a preferred detected range of cooking surface temperatures, relative to a nonpreferred range of cooking surface temperatures, the thermometer 10 clearly and simply communicates to a cook a cooking surface temperature associated with an improved quality outcome for cooking food.

It should be appreciated that the term “indicia” is representative to one or more visual depictions or representations associated with a detected range of temperatures. The term “indicia” can include one visual depiction or a plurality of visual depictions. In addition, the term “indicia” can include a marking, sign, symbol, color, or any other suitable distinguishing mark representative to a detected range of temperatures.

With reference now to FIG. 1, the thermometer 10 includes a base 14 (also referred to as an outer body 14) and a cover 18 coupled to the base 14. The cover 18 defines a first side 22 (also referred to as an upper side 22) of the thermometer 10, and the base 14 defines a second side 26 (also referred to as a lower side 26) of the thermometer 10. The cover 18 includes a cover body 30 and a handle 34. The cover body 30 is an annular portion that surrounds a portion of the base 14, which is described in further detail below. The cover body 30 includes an outer body surface 38. The outer body surface 38 defines a diameter greater than a diameter of the base 14. The handle 34 extends from the cover body 30. More specifically, the handle 34 extends from the cover body 30 in a direction away from the base 14. In the illustrated embodiment, the handle 34 connects to the cover body 30 at two locations. In other examples of embodiments, the handle 34 can connect to the cover body 30 at fewer or more locations (e.g., one, three, etc.). In the illustrated embodiment, the handle 34 forms a continuous connection with outer body surface 38 of the cover body 30. Stated another way, an outer handle surface 42 of the handle 34 is flush with the outer body surface 38. In other embodiments, the outer handle surface 42 can be positioned radially inward or outward of the outer body surface 38. In the illustrated embodiment, the handle 34 is integrally formed with the cover body 30. Stated another way, the cover body 30 and the handle 34 form one monolithic component. In other examples of embodiments, the handle 34 can be a separate component relative to the cover body 30 that is fastened or otherwise coupled to the cover body 30 (e.g., by a fastener, an adhesive, etc.). In the illustrated embodiment, the cover 18 is formed of silicone. In other examples of embodiments, the cover 18 can be formed of any suitable or desired insulating material, such as rubber. The handle 34 and associated cover 18 is configured to be formed of a material different than the base 14 such that heat transfer is minimized (or reduced) to the handle 34 and/or cover 18. This allows a user to safely move the thermometer 10 after use and associated contact with a high temperature surface, such as a cooking surface, while minimizing a burn risk.

The thermometer 10 also includes a lens 46 (also referred to as a dome 46) on the first side 22. The lens 46 is supported by the base 14 and the cover 18, which is described in further detail below. The lens 46 is formed of a transparent material such as glass or plastic, which allows internal components of the thermometer 10 to be viewed. In the illustrated embodiment, the lens 46 has a convex profile, which can provide, for example, a magnification effect upon the internal components of the thermometer 10. In other embodiments, the lens 46 can have any suitable profile, such as a flat profile.

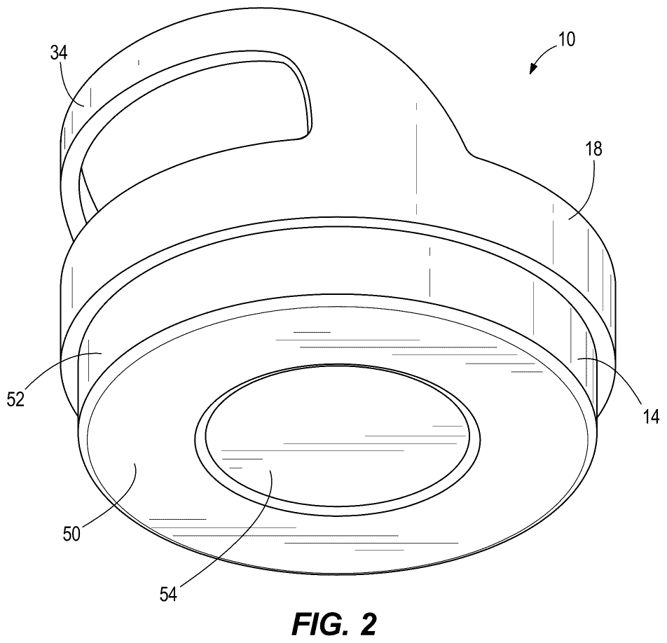

With reference now to FIG. 2, the base 14 includes a base floor 50 (also referred to as a support surface 50) and a base wall 52 extending from the base floor 50. In the illustrated embodiment, the base floor 50 defines a circular (or annular) outer circumference (or periphery) and the base wall 52 extends from the periphery of the base floor 50. The base 14 defines a surface 54. The surface 54 is longitudinally offset from the base floor 50 (or first surface 50). Accordingly, the surface 54 can also be referred to as an offset surface 54 (or a second surface 54). Stated another way, the offset surface 54 is positioned between the base floor 50 and the cover 18. The base floor 50 is positioned radially outward from the offset surface 54. In the illustrated embodiment, the offset surface 54 is circular, and the base floor 50 is a concentric ring positioned around the offset surface 54. The base floor 50 is configured to be positioned on or contact a cooking surface of a cooking vessel (not shown). The cooking vessel can be, for example, a pot, a pan, a griddle, or any other cookware configured to generate heat to cook food. The offset surface 54 is configured to provide structural strength or rigidity to the base 14 as the base 14 heats up. For example, as the base 14 is heated up by the cooking vessel, the base 14 can undergo undesirable deformations such as warping. In the illustrated embodiment, the offset surface 54 inhibits or restricts warping or other undesirable deformations of the base 14.

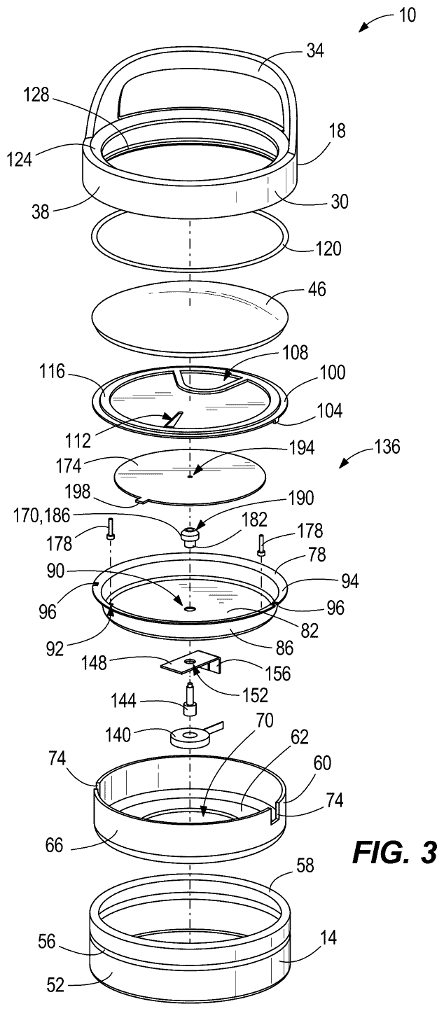

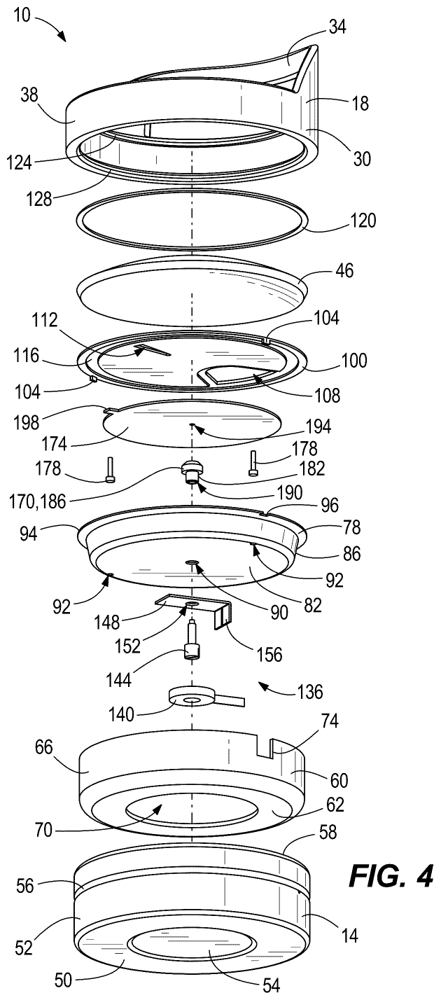

With reference now to FIGS. 3 and 4, the internal components of the thermometer 10 are illustrated. The base 14 includes a rib 56 extending around the base wall 52. In the illustrated embodiment, the rib 56 extends around an entire periphery of the base wall 52. In other examples of embodiments, the rib 56 can extend around a portion of the base wall 52 less than the entirety. In the illustrated embodiment, the rib 56 projects inward. Stated another way, the rib 56 projects from an inner surface of the base wall 52 to define a channel. In other examples of embodiments, the rib 56 can project outward, or from an outer surface of the base wall 52. The base 14 is coupled to the cover 18 by the rib 56, which is described in further detail below. The base wall 52 includes a curled portion 58. The curled portion 58 is positioned on a side of the base wall 52 opposite the base floor 50. The curled portion 58 extends inward. Stated another way, the curled portion 58 extends toward the base floor 50. The curled portion 58 improves the seal between the base 14, the cover 18, and the lens 46, which is described in further detail below. The base 14 is formed of a first material. In the illustrated embodiment, the base 14 is formed of food grade stainless steel.

The thermometer 10 includes a holder 60 (also referred to as an inner bottom 60) received in the base 14. The holder 60 includes a holder floor 62 and a holder wall 66 extending from the holder floor 62. More specifically, the holder floor 62 is circular, and the holder wall 66 extends from a periphery of the holder floor 62. The holder floor 62 includes a holder aperture 70. The holder aperture 70 is configured to receive the offset surface 54 of the base 14. The offset surface 54 can, for example, align the holder 60 within the base 14. Stated another way, due to the offset surface 54 extending through the holder aperture 70, the holder 60 is retained in a desired position and radial movement of the holder 60 is inhibited or prevented. The holder 60 includes a holder notch 74 in the holder wall 66. In the illustrated embodiment, the holder 60 includes a pair of holder notches 64. The pair of holder notches 74 are positioned opposite each other. Stated another way, the holder notches 74 are approximately one hundred eighty (180) degrees apart. In other examples of embodiments, the holder 60 can include any suitable number of holder notches 74 (e.g., one, three, etc.) spaced apart by any suitably distance or orientation. The holder 60 can be configured to increase a weight of the thermometer 10. The holder 60 is formed of a second material, different than the first material. In the illustrated embodiment, the holder 60 is formed to galvanized steel.

A bottom plate 78 is provided adjacent the holder 60. The bottom plate 78 includes a plate floor 82 and a plate wall 86 extending from the plate floor 82. More specifically, the plate floor 82 is circular, and the plate wall 86 extends from a periphery of the plate floor 82. The plate floor 82 includes a central aperture 90 and a radial aperture 92. The central aperture 90 extends through a central portion of the plate floor 82. The radial aperture 92 is radially offset from the central aperture 90. More specifically, the radial aperture 92 is positioned adjacent the plate wall 86. In the illustrated embodiment, the plate floor 82 includes two radial apertures 92 positioned opposite each other. Stated another way, the radial apertures 92 are one hundred eighty (180) degrees apart. In other examples of embodiments, the plate floor 82 can include a different number of radial apertures 92 (e.g., one, three, etc.) spaced apart by a different amount. The bottom plate 78 also includes a plate flange 94 extending from the plate wall 86. The plate flange 94 extends from the plate wall 86 in a direction away from the central aperture 90. In the illustrated embodiment, the plate flange 94 rests upon the holder wall 66. In other examples of embodiments, the plate flange 94 can be coupled to the holder wall 66 (e.g., by an adhesive, welding, fasteners, etc.). The bottom plate 78 includes a plate notch 96 in the plate flange 94. In the illustrated embodiment, the bottom plate 78 includes a pair of plate notches 96 positioned opposite each other. Stated another way, the plate notches 96 are approximately one hundred eighty (180) degrees apart. In other examples of embodiments, the bottom plate 78 can include any suitable number of plate notches 96 (e.g., one, three, etc.) spaced apart by any suitable distance or orientation. In the illustrated embodiment, each plate notch 96 is aligned with one respective radial aperture 92. Each illustrated plate notch 96 is also aligned with one respective holder notch 74, which is discussed in further detail below. The bottom plate 78 is formed of a third material, different than the first material and the second material. In the illustrated embodiment, the bottom plate 78 is formed of aluminum. The bottom plate 78 can have a thickness of 0.4 to 0.5 millimeters.

A stationary disc 100 (or disc 100 or stationary member 100) is coupled to the bottom plate 78. The stationary disc 100 includes a tab 104 extending from a periphery of the stationary disc 100. More specifically, the tab 104 extends from the periphery of the stationary disc 100 in a direction toward the bottom plate 78. The tab 104 can extend, for example, 1.5 to 2 millimeters from the periphery of the stationary disc 100. In the illustrated embodiment, the stationary disc 100 includes two tabs 104. Each tab 104 is received in one respective plate notch 96 to couple the stationary disc 100 to the bottom plate 78. Each tab 104 can be, for example, coupled to one respective plate notch 96 by a snap-fit connection or a press fit connection. Alternatively, each tab 104 can rest in one respective plate notch 96, such that the stationary disc 100 is coupled to the bottom plate 78 by a force of gravity. The connection between the stationary disc 100 and the bottom plate 78 is suitable such that a gauge 174 is configured to rotate relative to each component. Each tab 104 extends through the respective plate notch 96 and is also received in one respective holder notch 74. Each holder notch 74 can provide clearance for a size of each tab 104. The holder notch 74 also retains the tab 104 to inhibit the stationary disc 100 from rotating relative to the bottom plate 78. Stated another way, the tab 104 contacts sides of the respective holder notch 74 to retain the stationary disc 100 in a desired position relative to the bottom plate 78. The stationary disc 100 also includes a first window 108 (or a first aperture 108) and a second window 112 (or a second aperture 112). A user can see a temperature reading through the first and second windows 108, 112, which is described in further detail below. The first window 108 is larger than the second window 112. The first and second windows 108, 112 are positioned opposite each other. Stated another way, the first and second windows 108, 112 are one hundred eighty (180) degrees apart. The first window 108 is bordered by a raised portion 116. The raised portion 116 surrounds the first window 108 and around an entire periphery of the stationary disc 100. The raised portion 116 extends from the stationary disc 100 in an opposite direction than the tabs 104. The raised portion 116 can provide a guide for the lens 46. Stated another way, the raised portion 116 can align the lens 46 during assembly. The raised portion 116 can also contact and support an inner side of the lens 46 to prevent the lens 46 from damage (e.g., cracking, fracture, etc.). The stationary disc 100 is formed of the third material, different than the first material and the second material. In other examples of embodiment, the stationary disc 100 can be formed of a fourth material different than the first and second materials. In the illustrated embodiment, the stationary disc 100 is formed of aluminum.

With continued reference to FIGS. 3 and 4, a gasket 120 (also referred to as a seal ring 120) is provided between the base 14 and the lens 46. The gasket 120 can create a seal between the base 14 and the lens 46 to prevent liquid, steam, food, etc. from entering the thermometer 10. The gasket 120 can be composed of a resilient sealing material such as silicone or neoprene to allow the gasket 120 to deform between the base 14 and the lens 46 and improve the seal while enduring high temperature environments associated with cooking.

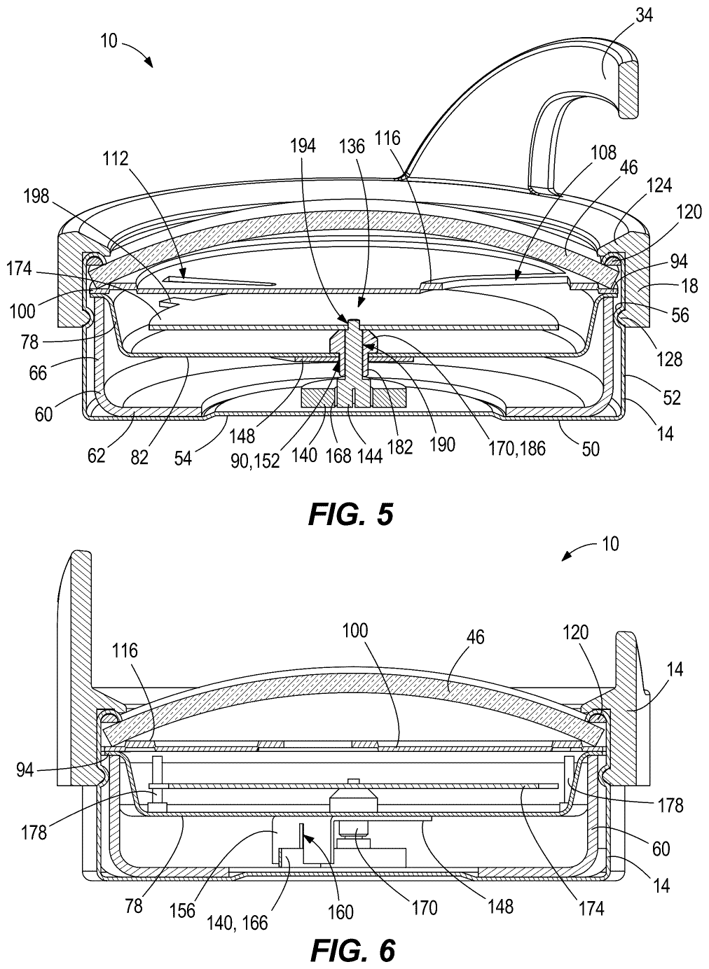

With continued reference to FIGS. 3 and 4, the cover 18 includes a flange 124 and a projection 128 extending from the cover body 30. The flange 124 and the projection 128 extend inward. Stated another way, the flange 124 and the projection 128 extend from an inner surface of the cover 18 opposite the outer body surface 38. In the illustrated embodiment, the flange 124 is an annular flange 124 and the projection 128 is an annular projection 128. Stated another way, both the flange 124 and the projection 128 extend around the entire cover body 30. The flange 124 is positioned between the projection 128 and the handle 34. More specifically, the flange 124 is positioned on a side of the cover body 30 adjacent the handle 34, and the projection 128 is positioned on a side of the cover body 30 opposite the handle 34. With reference to FIG. 5, the flange 124 includes a slot 132 that receives the curled portion 58 of the base 14. In the illustrated embodiment, the slot 132 is rectangular. Alternatively, in other examples of embodiments, the slot 132 can be arcuate, triangular, etc. The projection 128 is received in the rib 56 of the base 14 to couple the cover 18 to the base 14, which is described in further detail below.

With reference to FIGS. 3-5, the thermometer 10 includes an instrument assembly 136 (or a temperature detection assembly 136). The instrument assembly 136 is configured to detect a temperature, such as the temperature of the cooking surface of the cooking vessel. The instrument assembly 136 is further configured to responsively indicate the temperature. The instrument assembly 136 includes a coil 140 (also referred to as a thermometal 140 or a temperature detection member 140), an axle 144, and a bracket 148. The coil 140 includes a spiral of metallic material configured to expand and contract in response to a detected (or changing) temperature. The coil 140 can be a bimetallic coil formed of two different metals that expand and contract in different but predictable ways in response to exposure to heat or cold. This causes the coil 140 to expand and contract by a desired amount per a unit of temperature change. The coil 140 is operably connected (or fastened) to the axle 144. The axle 144 is configured to rotate in response to movement of the coil 140. The coil 140 and the axle 144 are not attached to the offset surface 54 of the holder 60. As such, the coil 140 and the axle 144 are configured to rotate relative to the offset surface 54. However, the coil 140 is sufficiently close to the offset surface 54, such that the coil 140 heats up or cools (e.g., by convection or radiation) as the base 14 is heated or cooled. The bracket 148 is coupled to the bottom plate 78. The bracket 148 includes a bracket aperture 152 aligned with the central aperture 90 of the bottom plate 78. The axle 144 extends through and is configured to rotate relative to the bracket aperture 152 and the central aperture 90 of the bottom plate 78. The axle 144 can be formed of brass, while the bracket 148 can be formed of galvanized steel. It should be appreciated that the temperature detection member 140 can include any suitable temperature detection member configured to responsively rotate the gauge 174 in response to a change in detected temperature. Accordingly, while a coil 140 (or thermometal 140) is illustrated, any suitable mechanical, thermomechanical, or chemi-mechanical device configured to respond to changes in detected temperature and that can be calibrated to detect a desired temperature range can be used.

With reference now to FIG. 6, the bracket 148 includes a bent portion 156 including a slot 160. The bent portion 156 is oriented at an angle relative to the plate floor 82. In the illustrated embodiment, the bent portion 156 extends in a direction generally perpendicular to the plate floor 82 of the bottom plate 78. The bent portion 156 defines the slot 160. A first end 166 of the coil 140 is coupled to the bracket 148. More specifically, the first end 166 is received in the slot 160 of the bracket 148. The first end 166 can further be fastened to the slot 160, for example by an adhesive, a weld, etc. A second end 168 of the coil 140 is coupled to the axle 144 (shown in FIG. 5). The second end 168 can be received by a slot defined by the axle 144. Further, the second end 168 can be fastened to the axle 144, for example by an adhesive, a weld, etc.

With reference back to FIG. 3-5, the instrument assembly 136 includes a screw cap 170, the gauge 174 (or rotating gauge 174), and a block 178 (shown in FIGS. 3 and 4). The block 178 can also be referred to as a nail 178. The screw cap 170 includes a screw body 182 and a screw head 186 positioned on a side of the screw body 182. The screw head 186 defines a diameter greater than a diameter of the screw body 182. A screw aperture 190 extends through the screw body 182 and the screw head 186. The screw aperture 190 is configured to receive the axle 144, which is described in further detail below. The rotating gauge 174 includes a gauge aperture 194 and a gauge tab 198. The gauge aperture 194 extends through a central portion of the rotating gauge 174. The gauge tab 198 extends from a periphery of the rotating gauge 174. The gauge aperture 194 is configured to receive the axle 144, such that the rotating gauge 174 rotates with the axle 144. The rotating gauge 174 can be formed of aluminum. The screw cap 170 and the block 178 can be formed of a rigid material. For example, the screw cap 170 and the block 178 can be formed of brass with a nickel plating.

With reference to FIG. 6, in the illustrated embodiment, the instrument assembly 136 includes two blocks 178 coupled to the bottom plate 78. Each block 178 can be, for example, pressed to one respective radial aperture 92 (shown in FIGS. 3 and 4) of the bottom plate 78. Alternatively, each block 178 can be coupled to the bottom plate 78, for example by an adhesive, a weld, etc. The blocks 178 are configured to limit rotation of the rotating gauge 174. More specifically, the gauge tab 198 (shown in FIG. 5) can come into contact with each block 178 as the gauge tab 198 rotates. When the gauge tab 198 contacts one of the blocks 178, the block 178 restricts further rotation of the rotating gauge 174, blocking it from further rotation. Accordingly, the blocks 178 can together define a rotation arc (not shown) of the rotating gauge 174. Stated another way, the blocks 178 can be positioned at two ends of the rotation arc, such that when a detected temperature is above or below a temperature represented within the rotation arc, the blocks 178 will restrict further movement of the rotating gauge 174. In other examples of embodiments, the instrument assembly 136 can include just one block 178 configured to come into contact with the gauge tab 198 at one end of the detected temperature range represented within the rotation arc.

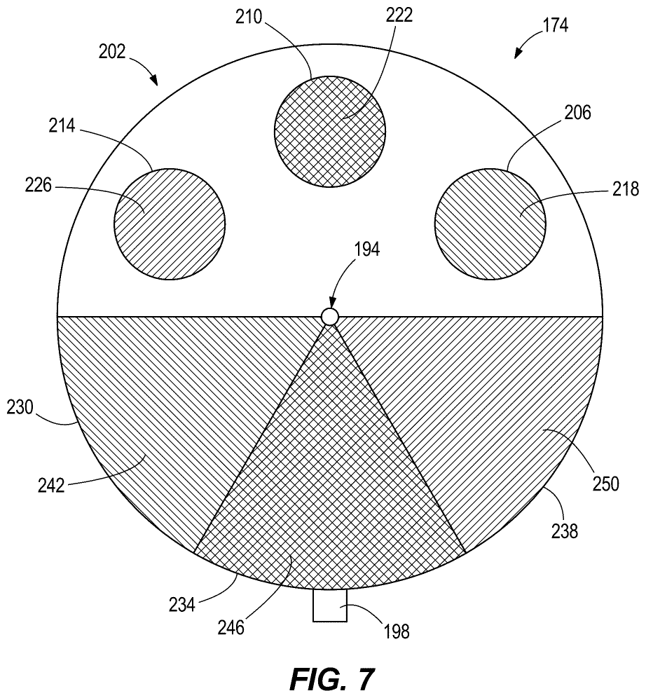

With reference now to FIG. 7, the rotating gauge 174 includes a plurality of indicia 202. In the illustrated embodiment, the rotating gauge 174 includes a first indicia 206, a second indicia 210, and a third indicia 214. The first indicia 206 is associated with a first temperature range (or a first temperature). The second indicia 210 is associated with a second temperature range (or a second temperature). The third indicia 214 is associated with a third temperature range (or a third temperature). The first, second, and third indicia 206, 210, 214 can collectively be referred to as a primary indicia 206, 210, 214. In the illustrated embodiment, the first, second, and third indicia 206, 210, 214 can include respective shapes, logos, and/or colors that provide a visual indication of a detected temperature range. The indicia 206, 210, 214 can have the same shape. In the illustrated embodiment, each of the first, second, and third indicia 206, 210, 214 have a circular shape. In other examples of embodiments, the first, second, and third indicia 206, 210, 214 can have different shapes (e.g., rectangular, triangular, etc.), and further can be differently shaped relative to each other. As one non-limiting embodiment, the first indicia 206 can be circular, the second indicia 210 can be rectangular, and the third indicia 214 can be triangular. In the illustrated embodiment, each of the first, second, and third indicia 206, 210, 214 has a different color (or pattern). The first indicia 206 has a first color 218, the second indicia 210 has a second color 222, and the third indicia 214 has a third color 226. The first, second, and third colors 218, 222, 226 are different from each other. In some examples of embodiment, each of the first, second, and third indicia 206, 210, 214 also define a different symbol. For examples, the first indicia 206 includes a blue flame, the second indicia 210 includes a colored logo, and the third indicia 214 includes a red exclamation mark (!). Accordingly, the first, second, and third indicia 206, 210, 214 are different to provide a visual representation to a user of a detected range of temperatures.

With continued reference to FIG. 7, the rotating gauge 174 also includes a plurality of secondary indicia 230, 234, 238. Each secondary indicia 230, 234, 238 is related to one of primary indicia 206, 210, 214. A fourth indicia 230 is associated with the first indicia 206. A fifth indicia 234 is associated with the second indicia 210. A sixth indicia 238 is associated with the third indicia 214. In the illustrated embodiment, each of the fourth, fifth, and sixth indicia 230, 234, 238 are sector shaped (or pie-shaped). The fourth, fifth, and sixth indicia 230, 234, 238 can be differently sized such that each defines a different area on the rotating gauge 174. In the illustrated embodiment, the sixth indicia 238 is larger than both the fourth and fifth indicia 230, 234. Each secondary indicia 230, 234, 238 is radially aligned with the associated primary indicia 206, 210, 214. In the illustrated embodiment, the first and fourth indicia 206, 230 are radially aligned, the second and fifth indicia 210, 234 are radially aligned, and the third and sixth indicia 214, 238 are radially aligned. Stated another way, the first indicia 206 is positioned on an opposite side of the gauge aperture 194 as the fourth indicia 230, the second indicia 210 is positioned on an opposite side of the gauge aperture 194 as the fifth indicia 234, and the third indicia 214 is positioned on an opposite side of the gauge aperture 194 as the sixth indicia 238. In other examples of embodiments, the primary and secondary indicia can be oriented relative to each other in any suitable manner to convey to a user the detected temperature ranges.

The fourth indicia 230 has a fourth pattern 242, the fifth indicia 234 has a fifth pattern 246, and the sixth indicia 238 has a sixth pattern 250. The fourth, fifth, and sixth patterns 242, 246, 250 are different from each other. Each pattern 242, 246, 250 can be a color, a pattern, a shading, or any other representative visual indicia to inform a user of a detected temperature range. In the illustrated embodiment, the fourth pattern 242 is related to the first pattern 218, the fifth pattern 246 is related to the second pattern 222, and the sixth pattern 250 is related to the third pattern 226. In other examples of embodiments, the fourth pattern 242 can be similar to the first pattern 218, the fifth pattern 246 can be similar to the second pattern 222, and the sixth pattern 250 can be similar to the third pattern 226. As one non-limiting example, related first and fourth patterns 218, 242 can be a blue flame for the first pattern 218 and a solid blue area for the fourth pattern 242. As another non-limiting example, related second and fifth patterns 222, 246 can be a colored (or shaded) logo for the second pattern 222 and a solid green area for the fifth pattern 246. As yet another non-limiting example, related third and sixth patterns 226, 250 can be a red exclamation mark (!) for the third pattern 226 and a solid red area for the sixth pattern 250. In other embodiments, the plurality of indicia 202 can include a different number of indicia (e.g., two, four, etc.), each of which is associated with a respective temperature range.

Each of the first, second, and third temperature range is associated with a detected temperature range. In the illustrated embodiment, the second indicia 210 (and the related fifth indicia 234) represent detection of the second temperature range (or a preferred temperature range). The second temperature range is calibrated to a Leidenfrost temperature for a cooking surface. When a cooking surface reaches a temperature to achieve a Leidenfrost effect, food generally has a reduced risk of sticking (or adhering) to the cooking surface. Accordingly, it can be preferred to cook food, such as a protein, when a cooking surface achieves a temperature range that achieves the Leidenfrost effect. For example, a desirable sear can be achieved on a protein (e.g., beef, chicken, pork, etc.) when cooking the protein at (or near) the Leidenfrost temperature. Since it can be difficult for a cook (or user) to assess when a cooking surface achieves a temperature that achieves the Leidenfrost effect, it is desirable to indicate to the cook (or user) when the cooking surface of the cooking vessel is at or around a temperature that achieves the Leidenfrost effect. It should be noted that cooking food at a temperature substantially above or below the temperature ranges that achieves the Leidenfrost effect can be undesirable (or not preferrable). For example, when cooking below the temperature range that achieves the Leidenfrost effect, the lower temperature can result in food sticking to the cooking surface. When cooking above the temperature range that achieves the Leidenfrost effect, the higher temperature can result in food burning, and in some limited situations, can lead to damage of the cooking vessel. For example, in response to the cooking vessel being heated to a temperature at or around 500 degrees Fahrenheit, the cooking vessel can undesirably begin to heat tint. Additionally, a non-stick coating on the cooking vessel, such as Polytetrafluoroethylene (PTFE), can begin to degrade at or around 500 degrees Fahrenheit.

Accordingly, in the illustrated embodiment, the second temperature range (associated with the second and fifth indicia 210, 234) is configured to be associated with the Leidenfrost point and a range of temperatures above and below the Leidenfrost point of the cooking surface. Accordingly, the second temperature range can be referred to as a detected Leidenfrost range. In the illustrated embodiment, the second temperature range is approximately 379 degrees Fahrenheit to approximately 430 degrees Fahrenheit.

The first temperature range (associated with the first and fourth indicia 206, 230) is configured to be associated with a temperature range below the second temperature range (or the Leidenfrost range) of the cooking surface. In the illustrated embodiment, the first temperature range is below 379 degrees Fahrenheit (or less than 379 degrees Fahrenheit).

The third temperature range (associated with the third and sixth indicia 214, 238) is configured to be associated with a temperature range above the second temperature range (or the Leidenfrost range) of the cooking surface. In the illustrated embodiment, the third temperature range is above 430 degrees Fahrenheit.

It should be appreciated that the second temperature range can be calibrated (or correlated or associated or programmed) relative to any suitable or desired range of detected temperatures of the cooking surface. In another example of an embodiment, the second temperature range can be 385 degrees Fahrenheit to 415 degrees Fahrenheit. In this embodiment, the first temperature range is below 385 degrees Fahrenheit, while the third temperature range is above 415 degrees Fahrenheit.

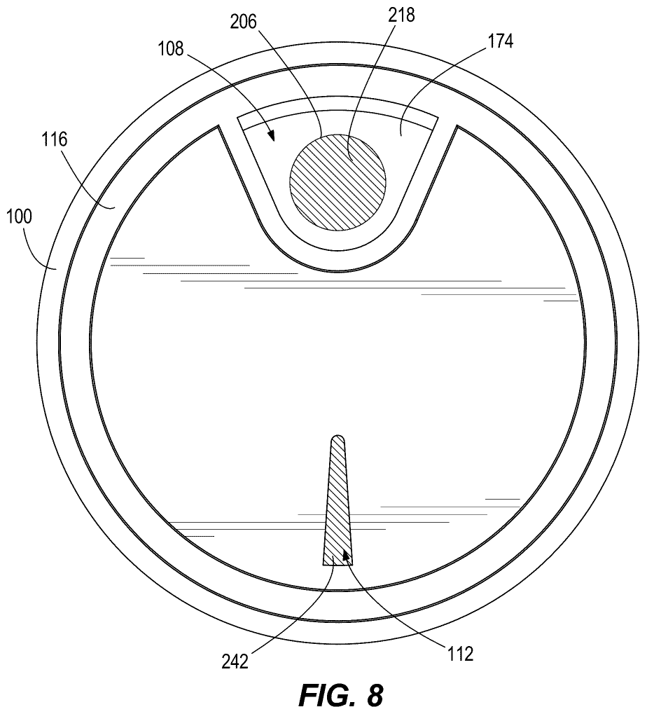

FIGS. 8-10 illustrate the thermometer 10 detecting the surface temperature of the cooking surface in the first temperature range, the second temperature range, and the third temperature range, respectively. With specific reference to FIG. 8, the thermometer 10 is detecting a cooking surface temperature in the first temperature range. In response to detecting a temperature in the first temperature range, the rotating gauge 174 is configured to rotate relative to the stationary disc 100 such that the first indica 206 is visible through the first window 108. Optionally or additionally, the fourth indicia 230 is visible through the second widow 112. Thus, the rotating gauge 174 is in a first position (or a first configuration). Exposing the first and/or fourth indica 206, 230 through the associated apertures 108, 112 in the disc 100 communicates to the user, through illustration, that the detected temperature of the cooking surface is lower (or cooler) than the preferred range for cooking (i.e., the second temperature range). Accordingly, the user can responsively increase the temperature by increasing the heat applied to the cooking surface. In the first position, the coil 140 detects that the temperature of the cooking surface is within the first temperature range (or below the second temperature range). Stated another way, in one example of an embodiment, in the first position, the coil 140 detects that the temperature of the cooking surface is less than 379 degrees Fahrenheit.

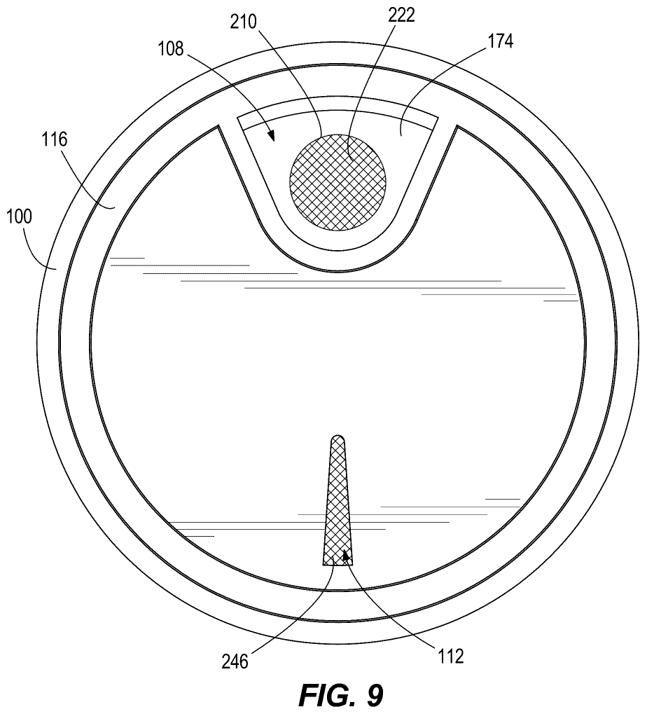

With specific reference to FIG. 9, the thermometer 10 is detecting a cooking surface temperature in the second temperature range. In response to detecting a temperature in the second temperature range, the rotating gauge 174 is configured to rotate relative to the stationary disc 100 such that the second indica 210 is visible through the first window 108. Optionally or additionally, the fifth indicia 234 is visible through the second widow 112. Thus, the rotating gauge 174 is in a second position (or a second configuration). Exposing the second and/or fifth indica 210, 234 through the associated apertures 108, 112 in the disc 100 communicates to the user, through illustration, that the detected temperature of the cooking surface is in the preferred range to cook food, such as proteins. Accordingly, the user can responsively cook food, while controlling the heat applied to the cooking surface to maintain the cooking surface temperature within the second temperature range. In the second position, the coil 140 detects the cooking surface is within the second temperature range (e.g., between 379 degrees Fahrenheit and 430 degrees Fahrenheit). The coil 140 and rotating gauge 174 can be calibrated such that the second indicia 210 is centered within the first window 108 and/or the fourth indicia is visible within the second window 112 when the temperature of the cooking surface is in a temperature range where the Leidenfrost effect occurs.

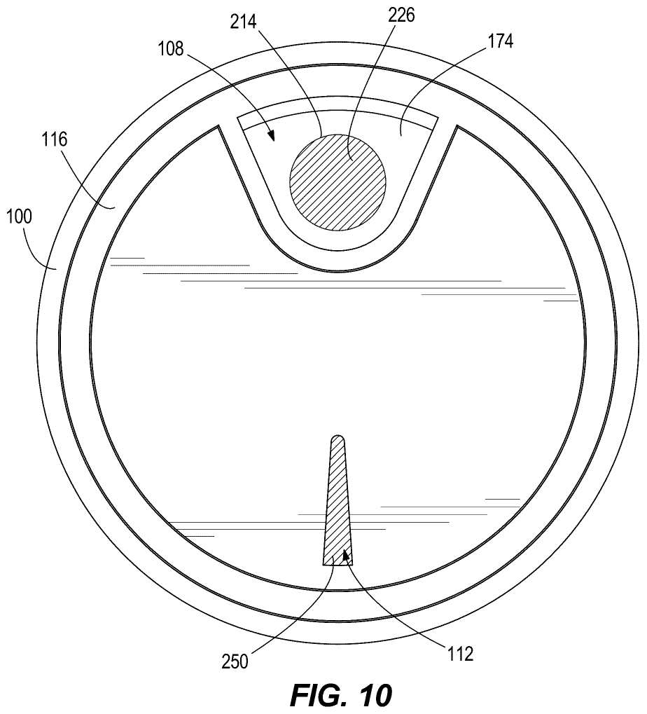

With specific reference to FIG. 10, the thermometer 10 is detecting a cooking surface temperature in the third temperature range. In response to detecting a temperature in the third temperature range, the rotating gauge 174 is configured to rotate relative to the stationary disc 100 such that the third indica 214 is visible through the first window 108. Optionally or additionally, the sixth indicia 238 is visible through the second widow 112. Thus, the rotating gauge 174 is in the third position (or a third configuration). Exposing the third and/or sixth indica 214, 238 through the associated apertures 108, 112 in the disc 100 communicates to the user, through illustration, that the detected temperature of the cooking surface is higher (or hotter) than the preferred range for cooking (i.e., the second temperature range). Accordingly, the user can responsively decrease the temperature by decreasing the heat applied to the cooking surface. In the third position, the coil 140 detects that the temperature of the cooking surface is within the third temperature range (or above the second temperature range). Stated another way, in one example of an embodiment, in the third position, the coil 140 detects that the temperature of the cooking surface is greater than 430 degrees Fahrenheit.

The thermometer 10 is assembled by first placing the holder 60 in the base 14. The holder 60 is positioned in the base 14, such that the offset surface 54 of the base 14 is received in the holder aperture 70. The instrument assembly 136 can then be coupled to the bottom plate 78. More specifically, the bracket 148 is coupled to the bottom plate 78, with the bracket aperture 152 aligned with the central aperture 90 of the bottom plate 78. The screw cap 170 is then inserted through the central and bracket apertures 90, 152. One or more blocks 178 can then be coupled to the bottom plate 78. At this point, the bottom plate 78, the bracket 148, the screw cap 170, and the one or more blocks 178 are coupled together. The axle 144 is then coupled to the coil 140 for rotation with the coil 140. The axle 144 is then extended through the screw aperture 190 and into the gauge aperture 194. At this point, the instrument assembly 136 is coupled to the bottom plate 78. The bottom plate 78 and the instrument assembly 136 are then inserted into the base 14, such that the plate flange 94 rests upon the holder wall 66. Alternatively, the plate flange 94 can be coupled to the holder wall 66. The stationary disc 100 is then coupled to the bottom plate 78. Each tab 104 on the stationary disc 100 is aligned with one respective plate notch 96. The stationary disc 100 is then pressed toward the bottom plate 78 to couple each tab 104 and respective plate notch 96 together. The lens 46 and the gasket 120 are then placed on top of the stationary disc 100. The lens 46 can be aligned with the raised portion 116 on the stationary disc 100. The gasket 120 can then be placed on the lens 46. The base 14 can be elastically deformed radially to allow the lens 46 and the gasket 120 to fit between the stationary disc 100 and the curled portion 58 of the base 14. Stated another way, the base wall 52 can be temporarily radially adjusted relative to the base floor 50 to allow the lens 46 and the gasket 120 to fit between the stationary disc 100 and the curled portion 58. Once the lens 46 and the gasket 120 are underneath the curled portion 58, the base wall 52 can move radially in an opposite direction to return to its original form. The cover 18 is then coupled to the base 14 and the lens 46. The cover 18 is pressed over the base 14 until the projection 128 is received in the rib 56. The projection 128 can, for example, snap into the rib 56. Once the projection 128 is received in the rib 56, the thermometer 10 is assembled.

During operation, the thermometer 10 can be placed within the cooking vessel being heated. For example, the thermometer 10 can be placed directly on to the cooking surface of the cooking vessel. As the cooking surface heats up, the base 14 will also heat up as the base 14 is made of a conductive material. In the illustrated embodiment, the conductive material is stainless steel (e.g., grade 304 stainless steel). Stainless steel can be preferred due to food safety properties. For example, stainless steel does not include chemicals that can leak onto the cooking surface, and stainless steel can be corrosion resistant. As the base 14 heats up, heat is transferred to the coil 140. As the coil 140 heats up, the coil 140 will rotate. The axle 144 and the rotating gauge 174 rotate with the coil 140. The axle 144 rotates relative to the screw cap 170. The rotating gauge 174 will begin at the first position, when the cooking surface is at a temperature within the first temperature range. At this point, the first indicia 206 is visible through the first window 108, and/or the fourth pattern 242 of the fourth indicia 230 is visible through the second window 112 (shown in FIG. 8). As the cooking surface continues to heat up, the coil 140 and thus the rotating gauge 174 will rotate. Once the cooking surface reaches the second temperature range, the second indicia 210 is visible through the first window 108, and/or the fifth pattern 246 of the fifth indicia 234 is visible through the second window 112 (shown in FIG. 9). As the cooking surface continues to heat up, the coil 140 and thus the rotating gauge 174 will rotate. Once the cooking surface reaches the third temperature range, the third indicia 214 is visible through the first window 108, and/or the sixth pattern 250 of the sixth indicia 238 is visible through the second window 112 (shown in FIG. 10).

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A thermometer configured to detect a range of temperatures of a cooking surface comprising:
a gauge including a first indicia and a second indicia;
a thermometal operably connected to the gauge; and
a stationary member defining a first aperture, the gauge configured to rotate relative to the stationary member,
wherein in response to the thermometal detecting a first range of temperatures, the gauge is configured to rotate relative to the stationary member to display the first indicia through the first aperture, and
wherein in response to the thermometal detecting a second range of temperatures, the gauge is configured to rotate relative to the stationary member to display the second indicia through the first aperture.

2. The thermometer of claim 1, the gauge including a third indica, wherein in response to the thermometal detecting a third range of temperatures, the gauge is configured to rotate relative to the stationary member to display the third indicia through the first aperture.

3. The thermometer of claim 2, wherein the first range of temperatures is less than the second range of temperatures, and the third range of temperatures is greater than the second range of temperatures.

4. The thermometer of claim 1, wherein the second range of temperatures is 379 degrees Fahrenheit to 430 degrees Fahrenheit.

5. The thermometer of claim 4, wherein the first range of temperatures is below 379 degrees Fahrenheit.

6. The thermometer of claim 4, wherein the first range of temperatures is above 430 degrees Fahrenheit.

7. The thermometer of claim 1, wherein the second range of temperatures is 385 degrees Fahrenheit to 415 degrees Fahrenheit.

8. The thermometer of claim 7, wherein the first range of temperatures is below 385 degrees Fahrenheit.

9. The thermometer of claim 7, wherein the first range of temperatures is above 415 degrees Fahrenheit.

10. The thermometer of claim 1, wherein the second range of temperatures is representative of a temperature the cooking surface reaches to achieve a Leidenfrost effect.

11. The thermometer of claim 1, wherein the thermometal is configured to form a coil that expands and contracts in response to a change in detected temperature.

12. The thermometer of claim 1, wherein the thermometal is a bimetallic coil.

13. The thermometer of claim 1, further comprising a base configured to receive the thermometal and the gauge, the base including a support surface, the thermometal positioned adjacent to the support surface.

14. The thermometer of claim 13, wherein the support surface defines a first surface and a second surface vertically offset from the first surface, the thermometal positioned adjacent to the second surface.

15. A thermometer comprising:
a gauge including a first indicia, a second indicia, a third indicia, a fourth indicia, a fifth indicia, and a sixth indicia;
a base;
a temperature detection member received by the base and configured to detect a temperature of a surface upon which the base is positioned, the temperature detection member operably connected to the gauge and configured to rotate the gauge in response to changes in the detected temperature; and
a stationary member defining a first aperture and a second aperture, the gauge configured to rotate relative to the stationary member,
wherein in response to the temperature detection member detecting a first range of temperatures, the gauge is configured to rotate relative to the stationary member to display the first indicia through the first aperture, and the fourth indicia through the second aperture,
wherein in response to the temperature detection member detecting a second range of temperatures, the gauge is configured to rotate relative to the stationary member to display the second indicia through the first aperture, and the fifth indicia through the second aperture, and
wherein in response to the temperature detection member detecting a third range of temperatures, the gauge is configured to rotate relative to the stationary member to display the third indicia through the first aperture, and the sixth indicia through the second aperture.

16. The thermometer of claim 15, wherein the first indica is different from the second indica and the third indica, and the second indicia is different from the third indicia.

17. The thermometer of claim 15, wherein the fourth indicia is a first color, the fifth indicia is a second color, and the sixth indicia is a third color, the first, second, and third colors being different.

18. The thermometer of claim 15, wherein the first temperature range is less than the second temperature range, and the third temperature range is greater than the second temperature range.

19. The thermometer of claim 18, wherein the second temperature range is 379 degrees Fahrenheit to 430 degrees Fahrenheit.

20. The thermometer of claim 18, wherein the second temperature range is 385 degrees Fahrenheit to 415 degrees Fahrenheit.
